(19) United States
(12) Patent Application Publication
(10) Pub. No.: US 2014/0358958 A1
(43) Pub. Date: Dec. 4, 2014

(54) SURFACING DIRECT APP ACTIONS

(71) Applicant: Microsoft Corporation, Redmond, WA (US)

(72) Inventors: Mirko Mandic, Seattle, WA (US); Robert Emmett Kolba, JR., Seattle, WA (US); Kieran Margaret Snyder, Seattle, WA (US); Max Glenn Morris, Seattle, WA (US); Jonathan Gordner, Seattle, WA (US); Kathleen M. Frigon, Seattle, WA (US)

(21) Appl. No.: 13/905,041

(22) Filed: May 29, 2013

(51) Int. Cl. G06F 17/30

(52) U.S. Cl. CPC G06F 17/30398
USPC 707/769

(57) ABSTRACT

One or more techniques and/or systems are provided for surfacing direct app actions. For example, a search interface may be configured to provide search results based upon queries submitted by users. Direct app actions may be surfaced through the search interface based upon a search context associated with search query formulation input associated with a search query that is input through the search interface. For example, map directions, a view social network vacation album, and/or other direct app actions may be surfaced through the search interface based upon a search query “Where is The Beach”. Direct app actions may be provided during formulation of the search query or after submission of the search query. Responsive to selection of a direct app action, a third party application (e.g., a locally installed application) may be invoked to perform the direct app action with little to no additional user input or navigation.

### BACKGROUND

Many users discover, explore, and/or interact with content using search functionality. For example, users frequently perform searches to identify a source, such as a website, capable to performing an action used to accomplish a search related task. For example, a user who desires to buy tickets for a concert performs a search through a search engine to find a ticket order website, for example. The user then navigates to the ticket order website to, among other things, select seats, submit payment information, etc. associated with buying tickets for the concert. Accomplishing search related tasks in this manner may involve numerous navigations and/or other user inputs, which may diminish the user's experience.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for surfacing direct app actions within a search interface are provided herein, where such direct app actions facilitate accomplishing search related tasks. For example, a search interface of an operating system (e.g., a search charm) may be configured to allow users to perform search queries for local files, internet content, multimedia information, directions, applications, and/or a plethora of other content. As provided herein, direct app actions (e.g., order movie tickets, view map directions, listen to music, order a coffee maker, share a picture through a social network, etc.) may be surfaced through the search interface so that a user may efficiently (e.g., with minimal user input) perform such actions directly through the search interface (e.g., without being transitioned away from the search interface to a content provider that requires additional and/or cumbersome user input to complete the actions). In this way, the user may efficiently accomplish search related tasks by invoking direct app actions directly through the search interface.

In an example, search query formulation input associated with a search query that is input through a search interface may be identified (e.g., a user may start to type the search query such that the search query formulation input corresponds to a partial search query, a user may submit the search query such that the search query formulation input corresponds to a submitted version of the search query, etc.). A search context may be determined based upon the search query formulation input and/or other information (e.g., a user preference for a particular application, a user profile describing the user's interests and/or other information, direct app actions and/or third party applications used by social network users to accomplish search related tasks above a popularity threshold, a location of the user, a user account with a music service, etc.). One or more direct app actions and/or third party applications capable of performing such direct app actions (e.g., locally installed applications on a device hosting the search interface) may be identified based upon the search context. For example, a map directions direct app action, which may be performed by a locally installed third party map application, may be identified based upon a search context derived from a current location of the user (e.g., the user may be located in a museum district) and/or the search query formulation input (e.g., a partial search query of “where is The Museum of Natu . . . ”).

The one or more direct app actions may be surfaced for invocation through the search interface. For example, a user interface element (e.g., a textual link, a button, a dropdown box, etc.) comprising a direct app action may be displayed within the search interface such that a user may select the direct app action through the user interface element. Responsive to selection of the direct app action, the third party application may be invoked, through the search interface, to perform the direct app action. For example, the user may select the map directions direct app action such that the map application may be invoked, through the search interface, to display driving directions to the Museum of Natural History (e.g., the user may specify a starting location through the search interface when selecting the map directions direct app action or a current location of the user (e.g., as determined via GPS) may be used as the starting location). In some embodiments, the direct app action may be performed by the third party application based upon the search interface (e.g., an operating system search interface of an operating system) invoking functionality exposed by the third party application to the operating system. In some embodiments, the direct app action may be performed without user interaction with the third party application and/or without transitioning the user away from the search interface (e.g., the search interface may directly invoke a radio application to play a music radio station without the user having to interface with the radio application). In this way, the user may efficiently accomplish search related tasks by invoking direct app actions through the search interface.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of surfacing direct app actions.

FIG. 2 is an illustration of an example of a computing environment through which a search interface may be hosted.

FIG. 3 is a component block diagram illustrating an exemplary system for surfacing direct app actions during a current formulation of a search query.

FIG. 4 is a component block diagram illustrating an exemplary system for surfacing direct app actions during a current formulation of a search query.

FIG. 5 is a component block diagram illustrating an exemplary system for surfacing direct app actions through an action launch interface.

FIG. 6 is a component block diagram illustrating an exemplary system for surfacing direct app actions through an action launch interface.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

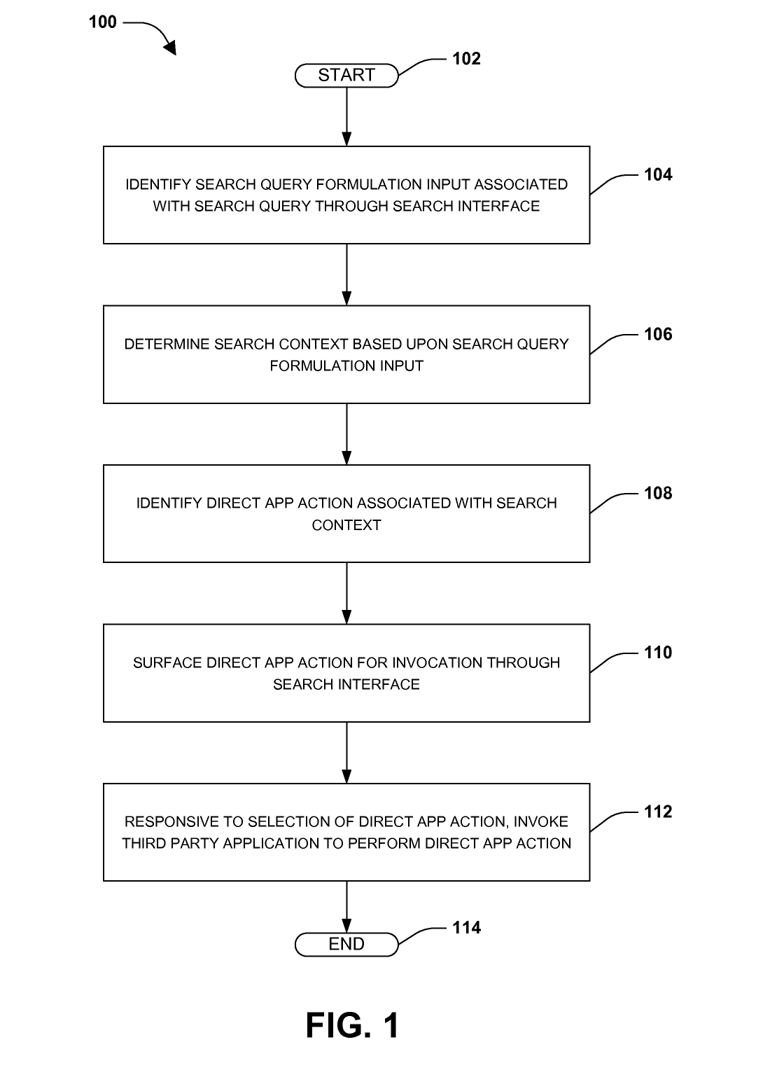

An embodiment of surfacing direct app actions is illustrated by an exemplary method 100 of FIG. 1. At 102, the method starts. A search interface may be configured to provide search results, such as local files, websites, and/or other content, based upon search queries submitted by users through the search interface. In an example, the search interface may be integrated into an operating system (e.g., the search interface may comprise an operating system user interface). In another example, the search interface may be hosted through a web service, a website, a search app, etc. At 104, search query formulation input associated with a search query may be identified through the search interface. In an example, the search query formulation input may correspond to a partial search query associated with a current formulation of the search query (e.g., the partial search query may be detected in real-time as a user inputs (e.g., types) the search query). In another example, the search query formulation input may correspond to a search submission of the search query (e.g., the user may type the entire search query and then initiate execution of the search query).

At 106, a search context may be determined based upon the search query formulation input. In an example, the search context may correspond to a search intent of the user (e.g., a search intent to obtain information associated with an upcoming concert by My Favorite Band may be determined based upon a search query formulation input of “My Favorite Band event . . . ”). In an example, the search context may be derived from contextual information such as a user profile identifying interests of the user. In another example, the search context may be derived from a location of the user (e.g., used to selectively identify a concert venue from a set of potential concert venues associated with the search query formulation input). In another example, the search context may be derived from a third party application previously executed by the user (e.g., used to selectively identify a preferred third party ticket application from a set of third party ticket applications capable of performing direct app actions). In another example, the search context may be derived from a user account (e.g., used to selectively identify a third party ticket application from a set of third party ticket applications based upon the user having an existing account with the third party ticket application such that the third party ticket application may provide an efficient ticketing purchase experience, for example, based upon saved purchasing information). In another example, the search context may be derived from a direct app action being performed by a threshold number of social network users above a popularity threshold (e.g., a popular ticketing app). It will be appreciated that the foregoing are merely non-limiting examples and that the instant application, including the scope of the appended claims, contemplate any one or more of a variety of manners for determining a search context.

At 108, one or more direct app actions associated with the search context may be identified. In example, a direct app action is an action that is capable of being performed by a third party application (e.g., an application different than the search interface, such as a web service, a website, a locally installed application, a remotely hosted application, an operating system, and/or any other application that may be different than the search interface). In an example, a third party application may be identified based upon the third party application exposing functionality to the search interface for invocation by the search interface to perform the direct app action. In another example, a local file system of a device providing the search interface may be searched to identify a set of third party applications, installed on the device, that expose functionality to the search interface for the search interface to invoke. One or more third party applications may be selected from the set of third party applications based upon such third party applications exposing functionality for performing the direct app action. In this way, support for third party applications may be extensible because the search interface may be capable of accessing newly installed third party applications on the device for invocation of direct app actions. In another example, a set of direct app actions associated with the search context may be identified (e.g., a purchase music ticket direct app action, a listen to music direct app action, a post to band social network profile direct app action, and/or a variety of other direct app actions that may be surfaced to the user through the search interface).

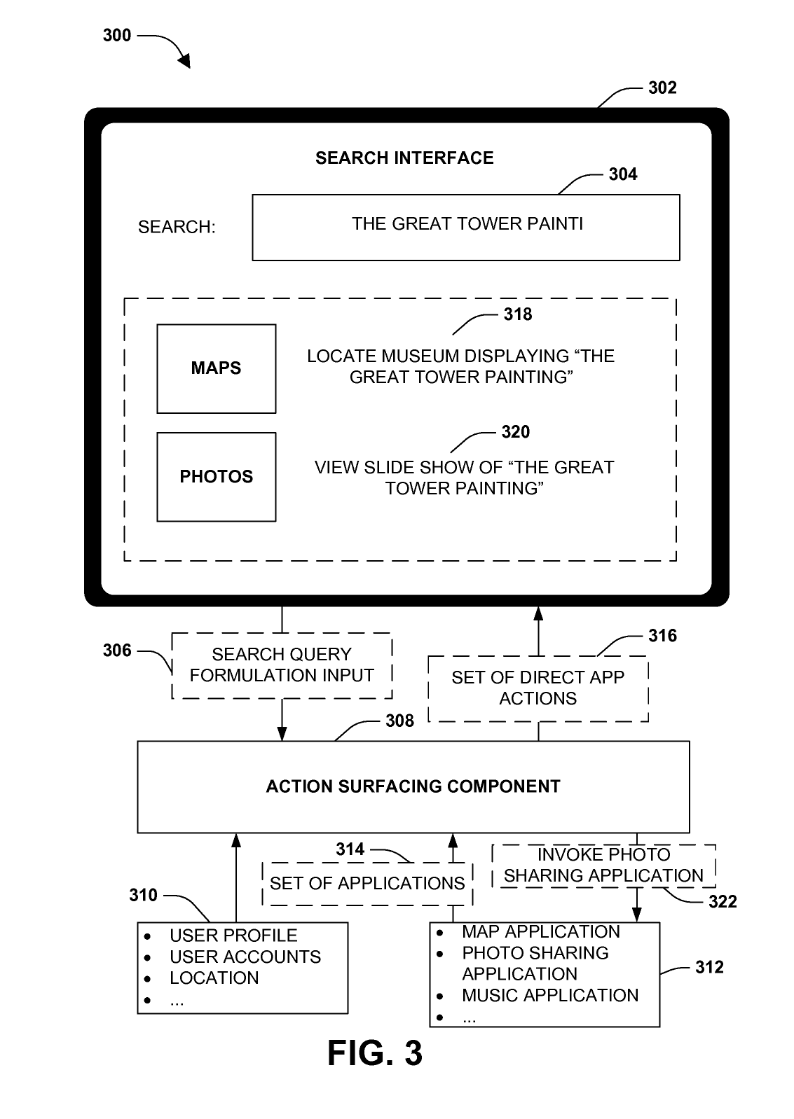

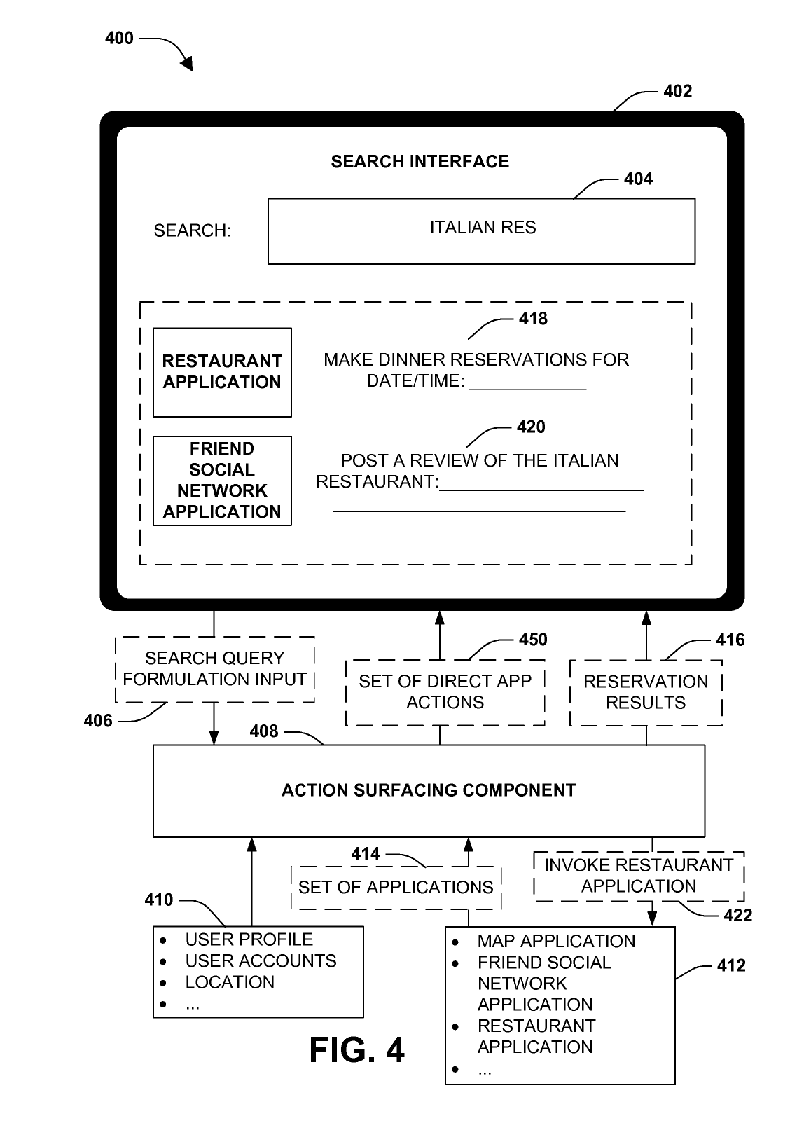

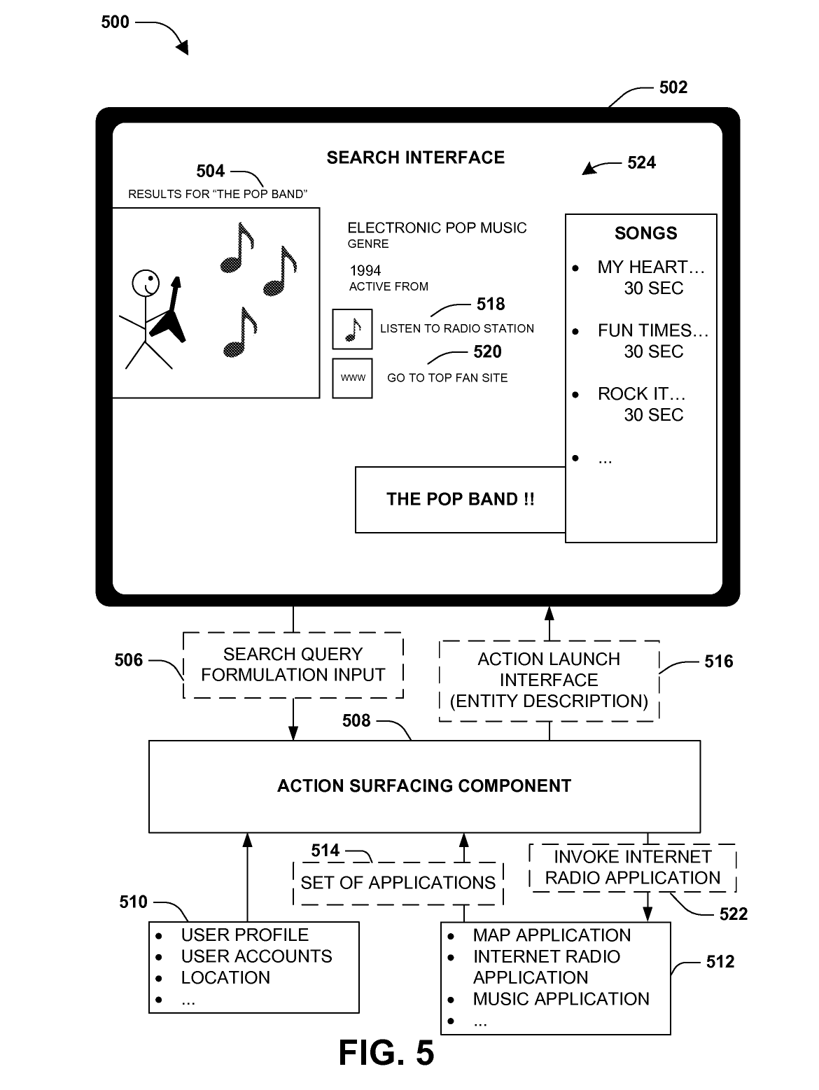

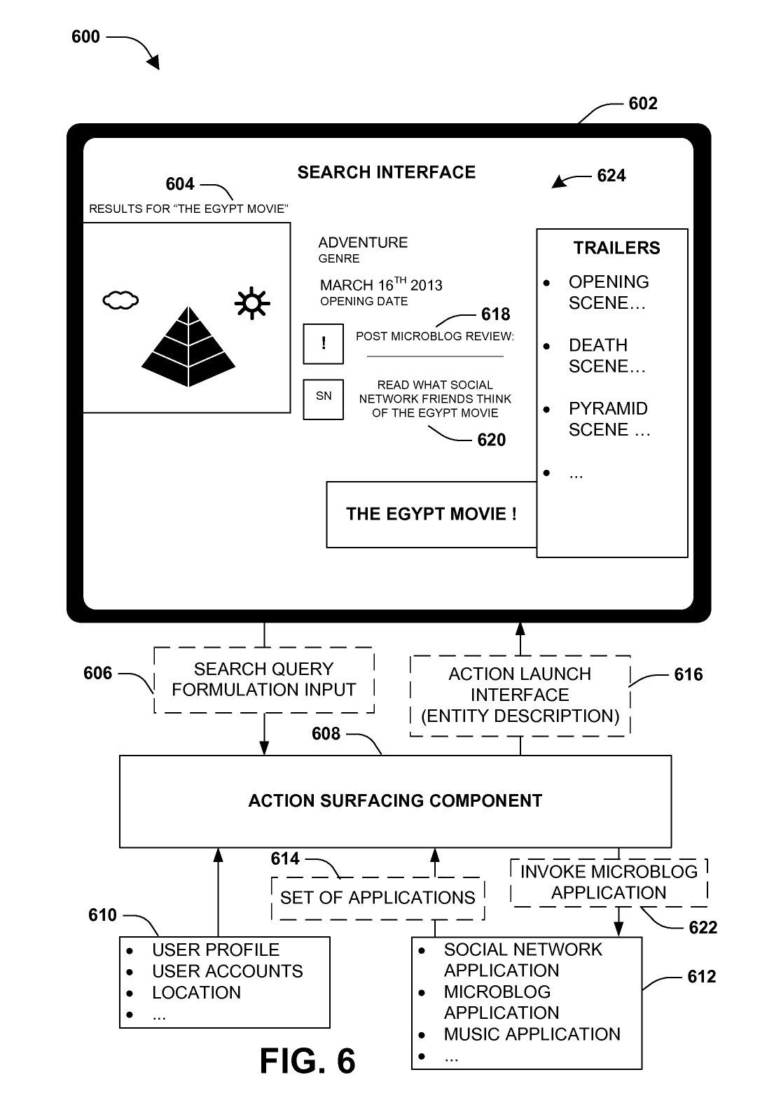

At 110, the one or more direct app actions may be surfaced for invocation through the search interface. In an example where the search query formulation input corresponded to a partial search query (e.g., the user may be currently formulating, such as typing, the search query), the one or more direct app actions may be surfaced as preliminary direct app action suggestions through a user interface element associated with the search interface (e.g., a text box, a button, a link, a dropdown box, etc.). In this way, the user may select a direct app action for invocation before submitting the search query (e.g., FIGS. 3 and 4). In an example where the search query formulation input corresponded to a search submission of the search query, an action launch interface hosted through the search interface may be displayed (e.g., FIGS. 5 and 6). The action launch interface may comprise the one or more direct app actions and/or one or more search results (e.g., images, videos, descriptive information, etc.) associated with the search context. If the search context corresponds to an entity (e.g., a particular person such as a musician, a particular place such as a tourist site, a particular thing such as a business, and/or or any other named/recognizable entities), then the action launch interface may comprise an entity description of the entity (e.g., FIGS. 5 and 6). The entity description may comprise interactive content associated with the entity, such as an ability to play music or a video associated with a musician entity.

In an example where multiple third party applications are capable of performing a direct app action, a third party application may be selected for surfacing with the direct app action based upon a user preference for the third party application (e.g., the user may have previously executed the third party application above an app preference threshold), a user account with the third party application (e.g., the user may have a music account with a music application such that the music application may be capable of playing full length songs, whereas a second music application may merely play 30 second previews because the user does not have an account with the second music application), social network user popularity associated with the third party application, and/or other factors. In another example, a set of third party applications capable of performing a direct app action may be surfaced. In this way, the user may select a particular third party application from the set of third party applications to perform the direct app action.

At 112, responsive to selection of a direct app action, a third party application may be invoked to perform the direct app action. In an example, the search interface may access and/or execute functionality exposed by the third party application, such as a locally installed application, to perform the direct app action. In another example, the third party application may be instructed to execute functionality used to perform the direct app action, and the result of the execution may be provided to a user associated with the search interface. In another example, the third party application may be invoked to perform the direct app action without user interaction with the third party application (e.g., a music application may be invoked to play a song without the user interacting with the music application). In another example, a result of the invocation may be provided without transitioning the user away from the search interface. For example, the result may be provided through the search interface, a second interface (e.g., displayed adjacent to the search interface), etc. In this way, the user may efficiently perform direct app actions through the search interface. At 114, the method ends.

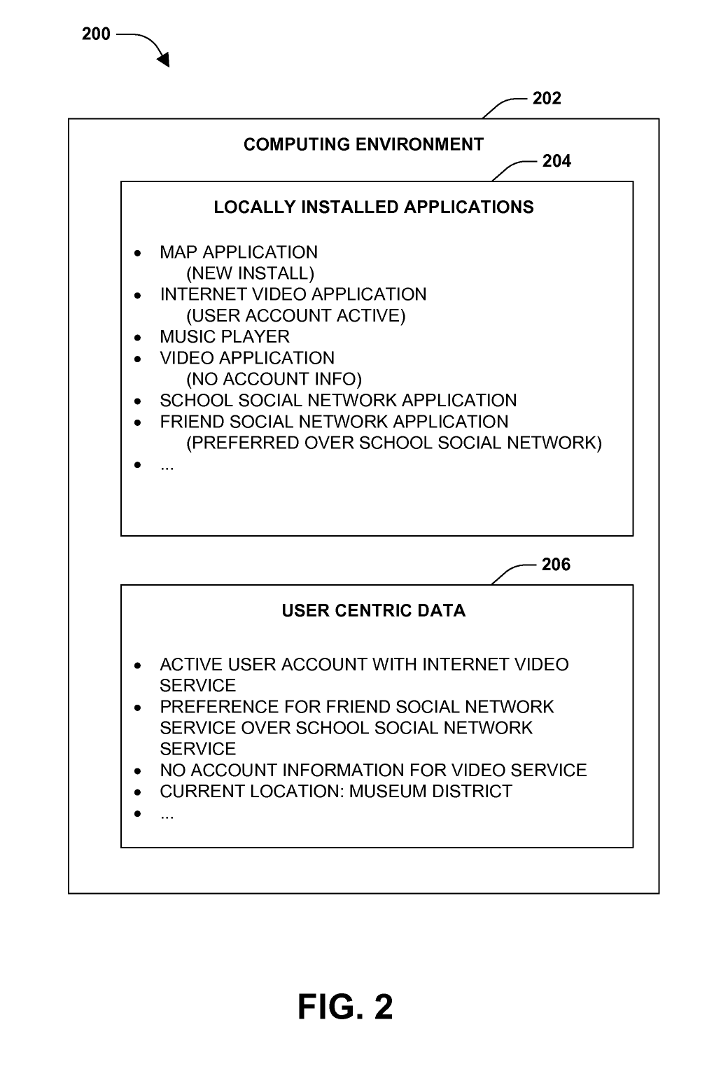

FIG. 2 illustrates an example 200 of a computing environment 202 through which a search interface may be hosted. The computing environment 202 may be hosted within a computing device, such as a tablet device, a mobile phone, a personal computer, and/or other devices. In an example, the computing environment 202 may comprise an operating system that may host the search interface through an operating system user interface (e.g., the search interface may be integrated into the operating system). The computing environment 202 may be configured to host one or more locally installed applications 204 (e.g., third party applications), such as a map application, an internet video application, a music player, a video application, a school social network application, a friend social network application, and/or a variety of other applications. The one or more locally installed applications 204 may be capable of performing direct app actions that may be surfaced through the search interface. Because the search interface may leverage locally installed applications for performance of direct app actions, the search interface may provide an extensible platform that may support new direct app actions (e.g., functionality exposed by a newly installed local application, such as the map application) and/or new third party applications (e.g., a newly installed local application, such as the map application, may be capable of performing a direct app action).

The computing environment 202 may comprise user centric data 206. The user centric data 206 may comprise a user profile describing the user, a location of the user, user accounts owned by the user, and/or a variety of other information that may be used to selectively surface direct app actions and/or access third party applications capable of performing direct app actions. In an example, the user centric data 206 may specify that the user has an active user account with an internet video service associated with the internet video application. Based upon the active user account with the internet video service, the internet video application may be selected for performance of a direct app action (e.g., instead of the video application with which the user may not have an account) because the internet video application may provide full length videos whereas the video application may merely provide previews. In another example, the user centric data 206 may specify that the user prefers a friend social network service over a school social network services, which may be used to surface the friend social network application, as opposed to the school social network application, for performing a direct app action such as posting a picture. In another example, the user centric data 206 may specify a current location of the user as a museum district, which may be used to identify a search context associated with a search query formulation input (e.g., a search context of directions to a museum may be identified for a partial search query “Where to see the New Painting by . . . ”. In this way, the user centric data 206 and/or the locally installed applications 204 may be used to determine a search context and/or surface direct app actions associated with the search context.

FIG. 3 illustrates an example of a system 300 for surfacing direct app actions during a current formulation of a search query. The system 300 may comprise an action surfacing component 308 associated with a search interface 302. The action surfacing component 308 may be configured to identify search query formulation input 306 associated with a search query through the search interface 302. For example, the search query formulation input 306 may correspond to a partial search query 304 of “The Great Tower Painti” associated with a current formulation of the search query. The action surfacing component 308 may determine a search context based upon the search query formulation input 306. For example, the action surfacing component 308 may determine that the user may have an interest in The Great Tower Painting. The action surfacing component 308 may utilize user centric data 310, such as a current location of the user being in a museum district, to determine the search context.

The action surfacing component 308 may be configured to identify one or more direct app actions associated with the search context that may be performed by third party applications. For example, the action surfacing component 308 may identify a map directions direct app action 318 and a view slide show direct app action 320 based upon the search context (e.g., the user having an interest in The Great Tower Painting) and/or the user centric data 310 (e.g., a current location of the user within a museum district, a user account with a photo sharing service, etc.). In this way, the action surfacing component 308 may identify a set of direct app actions 316 and/or a set of applications 314 from available third party applications 312 (e.g., one or more third party applications capable of performing the map directions direct app action 318 and/or the view slide show direct app action 320, such as a map application and/or a photo sharing application). The action surfacing component 308 may surface the map directions direct app action 318 and the view slide show direct app action 320 through the search interface 302 for invocation of such direct app actions through the search interface 302. Responsive to selection of a direct app action, such as the view slide show direct app action 320, the action surfacing component 308 may invoke 322 the photo sharing application to perform the view slide show direct app action 320. In this way, a user may efficiently perform a direct app action through the search interface 302.

FIG. 4 illustrates an example of a system 400 for surfacing direct app actions during a current formulation of a search query. The system 400 may comprise an action surfacing component 408 associated with a search interface 402. The action surfacing component 408 may be configured to identify search query formulation input 406 associated with a search query through the search interface 402. For example, the search query formulation input 406 may correspond to a partial search query 404 of “Italian res” associated with a current formulation of the search query. The action surface component 408 may determine a search context based upon the search query formulation input 406. For example, the action surfacing component 408 may determine that the user may have an interest in Italian restaurants. The action surfacing component 408 may utilize user centric data 410, such as a current location of the user and/or a user profile for the user, to determine the search context (e.g., the location of the user may be within a restaurant district, the user profile may specify an interest of the user in Italian restaurants, a prior transaction may indicate ordering from an Italian restaurant, etc.).

The action surfacing component 408 may be configured to identify one or more direct app actions associated with the search context that may be performed by third party applications. For example, the action surfacing component 408 may identify a make dinner reservations direct app action 418 and a post a restaurant review direct app action 420 based upon the search context (e.g., the user having an interest in Italian restaurants) and/or the user centric data 410 (e.g., a current location of the user within the restaurant district, a user account with a friend social network service, etc.). In this way, the action surfacing component 408 may identify a set of direct app actions 450 and/or a set of applications 414 from available third party applications 412 (e.g., one or more third party applications capable of performing the make dinner reservations direct app action 418 and/or the post a restaurant review direct app action 420, such as a restaurant application and/or a friend social network application). The action surfacing component 408 may surface the make dinner reservations direct app action 418 and the post a restaurant review direct app action 420 through the search interface 402 for invocation of such direct app actions through the search interface 402. Responsive to selection of a direct app action, such as the make dinner reservations direct app action 418 (e.g., the user may specify a date/time, restaurant name, party number, or other information through a user interface element of the search interface such that the user may invoke the make dinner reservations direct app action 418 with little to no additional user input, navigation to or interaction with the restaurant application), the action surfacing component 408 may invoke 422 the restaurant application to perform the make dinner reservations direct app action 418 (e.g., the action surfacing component 408 may pass data/time, restaurant name, party number, and/or other information input by the user through the search interface to the restaurant application). A result 416 of the invocation may be provided to the user (e.g., reservation results may be provided through the search interface 402, through a second interface, through an email confirmation, through the restaurant application, etc.). In this way, a user may efficiently perform a direct app action through the search interface 402.

FIG. 5 illustrates an example of a system 500 for surfacing direct app actions through an action launch interface. The system 500 may comprise an action surfacing component 508 associated with a search interface 502. The action surfacing component 508 may be configured to identify search query formulation input 506 associated with a search query through the search interface 502. For example, the search query formulation input 506 may correspond to a search submission 504 of the search query (e.g., “The Pop Band”). The action surface component 508 may determine a search context based upon the search query formulation input 506. For example, the action surfacing component 508 may determine that the user may have an interest in a particular band, The Pop Band. The action surfacing component 508 may utilize user centric data 510, such as a user profile specifying an interest of the user in music, to determine the search context.

The action surfacing component 508 may be configured to identify one or more direct app actions associated with the search context that may be performed by third party applications. For example, the action surfacing component 508 may identify a play radio station direct app action 518 and/or a visit top fan site direct app action 520. In this way, the action surfacing component 508 may identify a set of direct app actions and/or a set of applications 514 from available third party applications 512 (e.g., one or more third party applications capable of performing the play radio station direct app action 518 and/or the visit top fan site direct app action 520). For example, the action surfacing component 508 may identify an internet radio application, a music application, a music fan application, and/or other third party applications based upon the search context (e.g., the user having an interest in The Pop Band) and/or the user centric data 510 (e.g., a user account with an internet radio service may indicate that the internet radio application may provide an improved user experience by playing non-commercial content as opposed to 30 second previews that the music application may play due to the user not having an account with the music application).

The action surfacing component 508 may surface the play radio station direct app action 518 (e.g., invokable by the internet radio application to provide an improved user experience of non-commercial content due to the user account with the internet radio service) and/or the visit top fan site direct app action 520 through the search interface 502 for invocation of such direct app actions through the search interface 502. In an example, the action surfacing component 508 may display 516 an action launch interface comprising the direct app actions and/or an entity description 524 comprising interactive content associated with the entity (e.g., a description of The Pop Band, an ability to preview songs by The Pop Band, an image of The Pop Band, etc.). Responsive to selection of a direct app action, such as the play radio station direct app action 518, the action surfacing component 508 may invoke 522 the internet radio application to perform the play radio station direct app action 518 (e.g., the action surfacing component 508 may pass user account credentials from the user account with the internet radio service and/or information regarding The Pop Band to the internet radio app). In this way, a user may efficiently perform a direct app action through the search interface 502.

FIG. 6 illustrates an example of a system 600 for surfacing direct app actions through an action launch interface. The system 600 may comprise an action surfacing component 608 associated with a search interface 602. The action surfacing component 608 may be configured to identify search query formulation input 606 associated with a search query through the search interface 602. For example, the search query formulation input 606 may correspond to a search submission 604 of the search query (e.g., “The Egypt Movie”). The action surface component 608 may determine a search context based upon the search query formulation input 606. For example, the action surfacing component 608 may determine that the user may have an interest in a particular movie, The Egypt Movie. The action surfacing component 608 may utilize user centric data 610, such as a user profile specifying an interest of the user in writing reviews on movies, to determine the search context.

The action surfacing component 608 may be configured to identify one or more direct app actions associated with the search context that may be performed by third party applications. For example, the action surfacing component 608 may identify a post microblog review direct app action 618 and/or a read social network posts direct app action 620. In this way, the action surfacing component 608 may identify a set of direct app actions and/or a set of applications 614 from available third party applications 612 (e.g., one or more third party applications capable of performing the post microblog review direct app action 618 and/or the read social network posts direct app action 620, such as a social network application and/or a microblog application). For example, the action surfacing component 608 may identify the social network application based upon a user account with a social network and/or may identify the microblog application based upon a user account with a microblog service.

The action surfacing component 608 may surface the post microblog review direct app action 618 and the read social network posts direct app action 620 through the search interface 602 for invocation of such direct app actions through the search interface 602. In an example, the action surfacing component 608 may display 616 an action launch interface comprising the direct app actions and/or an entity description 624 comprising interactive content associated with the entity (e.g., a description of The Egypt Movie, an ability to view trailers of The Egypt Movie, an image of The Egypt Movie, etc.). Responsive to selection of a direct app action, such as the post microblog review direct app action 618, the action surfacing component 608 may invoke 622 the microblog application to perform the post microblog review direct app action 618 (e.g., the action surfacing component 608 may pass user account credentials from the user account with the microblog service, a movie review specified by the user through the search interface 602, and/or information regarding The Egypt Movie to the microblog application). In this way, a user may efficiently perform a direct app action through the search interface 602.

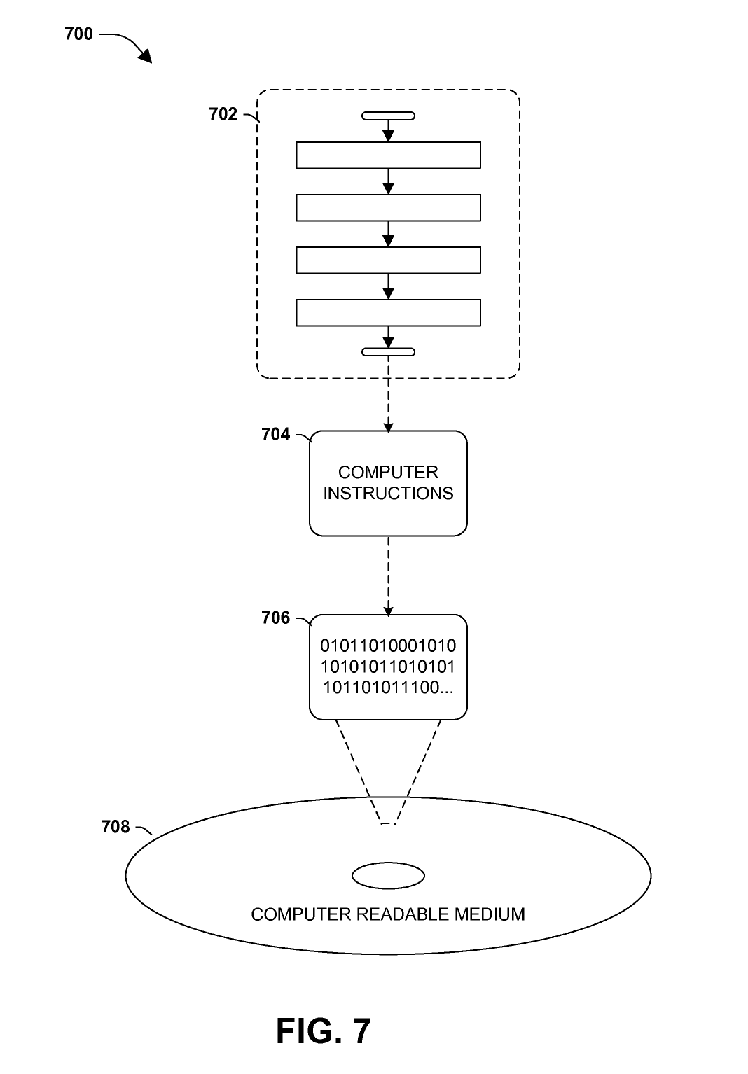

Still another embodiment involves a computer-readable medium comprising processor-executable instructions configured to implement one or more of the techniques presented herein. An example embodiment of a computer-readable medium or a computer-readable device that is devised in these ways is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1, for example. In some embodiments, the processor-executable instructions 704 are configured to implement a system, such as at least some of the exemplary system 300 of FIG. 3, least some of the exemplary system 400 of FIG. 4, least some of the exemplary system 500 of FIG. 5, and/or least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

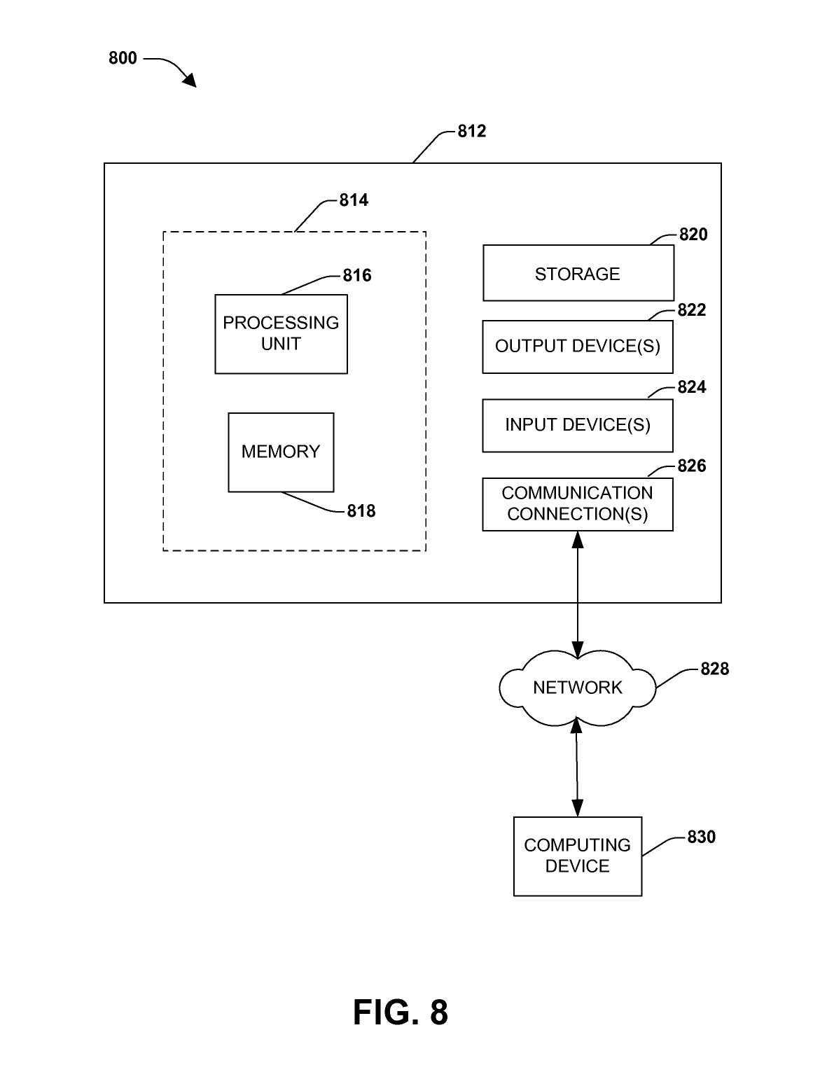

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for surfacing direct app actions, comprising:
identifying search query formulation input associated with a search query through a search interface;
determining a search context based upon the search query formulation input;
identifying a direct app action associated with the search context, the direct app action capable of being performed by a third party application;
surfacing the direct app action for invocation through the search interface; and
responsive to a selection of the direct app action, invoking the third party application to perform the direct app action.

2. The method of claim 1, the search interface comprising an operating system user interface.

3. The method of claim 1, comprising:
identifying the third party application based upon the third party application exposing functionality to the search interface, for invocation by the search interface, to perform the direct app action.

4. The method of claim 1, comprising:
searching a local file system of a device providing the search interface to identify a set of third party applications, installed on the device, that expose functionality to the search interface for the search interface to invoke; and
selecting the third party application from the set of third party applications based upon the third party application exposing functionality for performing the direct app action.

5. The method of claim 1, the third party application invoked to perform the direct app action without user interaction with the third party application.

6. The method of claim 1, the identifying comprising identifying a set of direct app actions associated with the search context, and the surfacing comprising surfacing the set of direct app actions for invocation through the search interface.

7. The method of claim 1, the invoking the third party application to perform the direct app action comprising:
instructing the third party application to execute functionality used to perform the direct app action and to provide a result of the execution to a user associated with the search interface.

8. The method of claim 1, comprising:
providing a result of the invocation without transitioning a user away from the search interface.

9. The method of claim 1, comprising:
providing a result of the invocation through at least one of the search interface or a second interface.

10. The method of claim 1, the surfacing comprising surfacing a set of third party applications capable of performing the direct app action, and the invocation comprising invoking the third party application to perform the direct application responsive to the selection of the third party application from the set of third party applications.

11. The method of claim 1, the search query formulation input corresponding to a partial search query associated with a current formulation of the search query, and the surfacing comprising surfacing the direct app action for invocation through the search interface as a preliminary direct app action suggestion.

12. The method of claim 1, the search query formulation input corresponding to a search submission of the search query, and the surfacing comprising displaying an action launch interface hosted through the search interface, the action launch interface comprising the direct app action and one or more search results associated with the search context.

13. The method of claim 12, the action launch interface comprising an entity description of an entity associated with the search context, the entity description comprising interactive content associated with the entity.

14. The method of claim 1, the identifying a direct app action associated with the search context comprising:
identifying the direct app action based upon at least one of:
the third party application being previously executed by a user above an app preference threshold;
a location of the user;
a user account owned by the user;
the direct app action being performed by a threshold number of social network users above a popularity threshold; or
a user profile of the user.

15. A system for surfacing direct app actions, comprising:
an action surfacing component configured to:
identify search query formulation input associated with a search query through a search interface;
determine a search context based upon the search query formulation input;
identify a direct app action associated with the search context, the direct app action capable of being performed by a third party application;
surface the direct app action for invocation through the search interface; and
responsive to a selection of the direct app action, invoke the third party application to perform the direct app action.

16. The system of claim 15, the action surfacing component configured to:
search a local file system of a device providing the search interface to identify a set of third party applications, installed on the device, that expose functionality to the search interface for the search interface to invoke; and
select the third party application from the set of third party applications based upon the third party application exposing functionality for performing the direct app action.

17. The system of claim 15, the action surfacing component configured to:
provide a result of the invocation without transitioning a user away from the search interface.

18. The system of claim 15, the search query formulation input corresponding to a partial search query associated with a current formulation of the search query, and action surfacing component configured to:
surface the direct app action for invocation through the search interface as a preliminary direct app action suggestion.

19. The system of claim 15, the action surfacing component comprising an operating system component of an operating system, and the third party application comprising an application installed on a device hosting the operating system.

20. A computer readable medium comprising instructions which when executed at least in part via a processing unit perform a method for surfacing direct app actions, comprising:
identifying search query formulation input associated with a search query through a search interface provided through a device, the search interface hosted by an operating system installed on the device;
determining a search context based upon the search query formulation input;
identifying a set of direct app actions associated with the search context, a first direct app action within the set of direct app actions capable of being performed by a first local app installed on the device;
surfacing the set of direct app actions for invocation through the search interface; and
responsive to a selection of the first direct app action:
invoking the first local app to perform the first direct app action without transitioning a user of the search interface away from the search interface; and
providing a result of the invocation.
